(19) United States
(12) Patent Application Publication
(10) Pub. No.: US 2017/0260934 A1
(43) Pub. Date: Sep. 14, 2017

(54) Efficiency enhanced fuel molecule charging devices and methods

(71) Applicant: Joshua R&D Technologies, LLC, Plano, TX (US)

(72) Inventor: David R. Pickett, Plano, TX (US)

(73) Assignee: Joshua R&D Technologies, LLC, Plano, TX (US)

(21) Appl. No.: 14/998,941

(22) Filed: Mar. 8, 2016

(51) Int. Cl. F02M 27/04; F23C 99/00

(52) U.S. Cl. CPC F02M 27/045; F23C 99/001; F23K 2301/101

(57) ABSTRACT

Devices and methods are disclosed for charging fuel molecules in a delivery conduit. The devices are monopole charging devices having at least three individual magnets. A one piece orienting mount having insert formations equal in number to the number of magnets and spaced a selected distance from each other receives and holds the magnets, and is secured around the delivery conduit. The mount holds the magnets in an orientation with a common pole of each contacting the conduit and the opposite pole of each spaced from and facing away from the conduit.

### FIELD OF THE INVENTION

This invention relates to apparatus and methods for manipulating fuel characteristics in a combustion mechanism, and, more particularly, relates to devices and methods for manipulating charge characteristics of fuel moving through a conduit.

### BACKGROUND OF THE INVENTION

When a combustion fuel is more efficiently burned it will deliver more heat and power with less pollution. It has long been suspected that when any liquid or gaseous fuel is charged (or “ionized”) it will burn more thoroughly.

Liquid and gaseous fuels most often enter a burner from a fuel delivery line in molecule clusters. These clusters are susceptible to less efficient burning than if the molecules where presented at the burner more discretely. Fuel line magnetic charging apparatus, sometimes referred to as magnetic fuel ionizers or particle chargers, have been heretofore suggested and/or utilized in an effort to cause these clusters to break apart. Such apparatus have been suggested for use in association with water heaters, furnaces, boilers, cookers or various engines. Some of these apparatus are attached to a motor's or burner's main fuel delivery line to directly expose the line to the magnets' charge. For an overview of a variety of various magnet actuating configurations and arrangements see, for example, U.S. Patent Application Publication Nos. 2013/0327304, 2014/0262939, 2013/0074803, and 2009/0095267, and U.S. Pat. Nos. 6,386,187, 6,041,763, 8,999,158, 7,490,593, 5,816,227, 8,517,000, and 8,432,159.

Most of these apparatus have been implemented with charge orientations or charge manipulation that impede their efficiency. Moreover use of such apparatus in high heat or high vibration environments (such as with gasoline or diesel motors) has often led to apparatus failure or duty cycle curtailment due to inadequate consideration of mounting stability and magnet shielding. Further improvement in this field could thus still be utilized.

### SUMMARY OF THE INVENTION

This invention provides devices and methods for enhancing efficiency of various fuel combustion devices such as burner, combustion chambers and the like. In particular, fuel charging devices and methods are provided which are implemented with a monopole charge orientation. The devices are implemented so that a long duty cycle is obtained even in high heat or high vibration environments.

The fuel charging devices of this invention are mountable at a length of non-ferrous fuel delivery conduit and include an array of magnets (at least three individual magnets having positive and negative poles). Each one of the magnets is oriented and spaced in the array to be located at a different circumferential location around the conduit with a common pole of each magnet contacting the conduit thereat (preferably the negative pole for most implementations, though a positive monopolar orientation could also be utilized). The magnets are arrayed radially to define polar axes through about the center of the conduit and through the magnets' poles, each magnet located off polar axis of any other one of the magnets in the array.

A one piece orienting mount having insert formations equal in number to the number of the individual magnets in the array is provided, the insert formations spaced a selected distance from each other and sized to receive and hold at least a part of one of the magnets therein. The magnets are each oriented in a different one of the insert formations with the poles of each of the magnets facing the same directions in the mount.

The fuel molecule charging methods of this invention includes the steps of orienting a plurality of magnets with a common pole of each facing the same direction and securing the magnets to a fuel delivery conduit adjacent to an area of fuel combustion so that the common pole of each of the magnets contacts the conduit and an opposite pole of each is spaced from and faces away from the conduit.

It is therefore an object of this invention to provide devices and methods for enhancing efficiency of various fuel combustion devices.

It is another object of this invention to provide fuel charging devices and methods which are implemented with a monopole charge orientation.

It is still another object of this invention to provide fuel molecule charging devices that are implemented to achieve long duty cycles in high heat and/or high vibration environments.

It is another object of this invention to provide a fuel charging device mountable at a length of non-ferrous fuel delivery conduit, the device including an array of magnets including at least three individual magnets having positive and negative poles, each one of the magnets oriented and spaced in the array to be located at a different circumferential location around the conduit with a common pole of each contacting the conduit at its the different circumferential location, the magnets arrayed radially to define polar axes through about the center of the conduit and through the poles of each one of the magnets, each one the magnets located off polar axis of any other one of the magnets in the array.

It is still another object of this invention to provide a monopole fuel molecule charging device for mounting on a fuel delivery conduit that includes at least three individual magnets having positive and negative poles, a one piece orienting mount having insert formations equal in number to the number of the individual magnets and spaced a selected distance from each other, each of the insert formations sized to receive and hold at least a part of one of the magnets therein, and each one of the magnets oriented in a different one of the insert formations of the mount with the poles of each of the magnets facing the same directions in the mount.

It is yet another object of this invention to provide a fuel molecule charging method that includes the steps of orienting a plurality of magnets having positive and negative poles with a common pole of each facing the same direction, and securing the magnets to a fuel delivery conduit adjacent to an area of fuel combustion so that the common pole of each of the magnets contacts the conduit and an opposite pole of each is spaced from and faces away from the conduit to thereby define a monopole magnet array around the conduit.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a schematic illustration of a preferred embodiment of the device of this invention;

FIG. 2 is another schema illustrating a means for holding the device of this invention in association with a delivery conduit;

FIG. 3 is a side view schema taken relative to FIG. 2 showing the device of this invention mounted at the delivery conduit;

FIG. 4 is a perspective view of the orienting mount illustrated in FIGS. 2 and 3;

FIG. 5 is a manufacturing layout side view of the orienting mount suggested in FIGS. 2 through 4;

FIG. 6 is a schematic illustration of a second preferred embodiment of the device of this invention;

FIG. 7 is a schematic illustration of an embodiment of the device of this invention including a specially adapted delivery conduit; and

FIG. 8 is a perspective view of a multi-chambered orienting mount for utilization with another implementation of the device of this invention.

### DESCRIPTION OF THE INVENTION

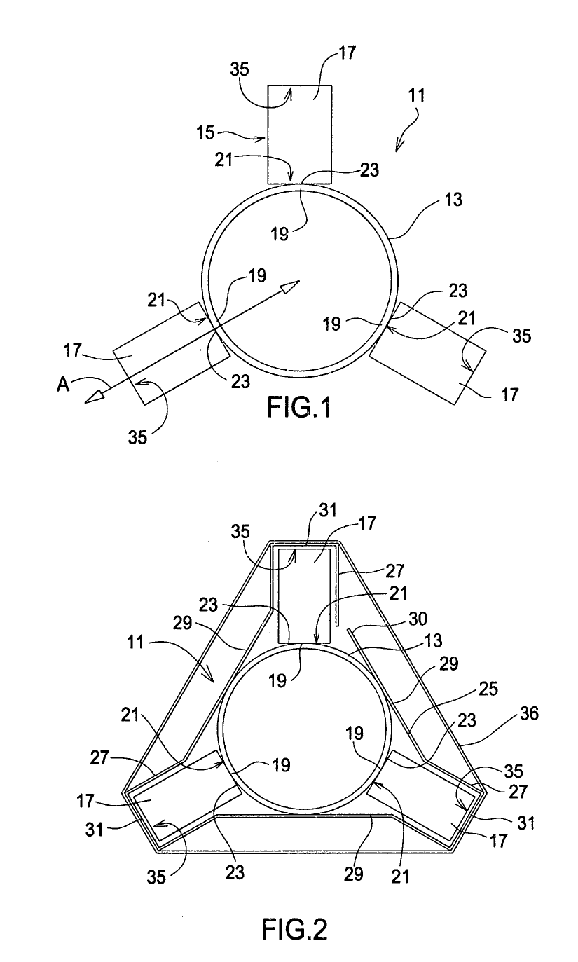

One preferred embodiment 11 of a fuel charging device of this invention mountable at a length of non-ferrous fuel delivery conduit 13 is illustrated in FIGS. 1 through 3 (delivery conduit 13 may not be made of any magnetically conductive material). The device 11 preferably includes an array 15 of magnets 17 (preferably including at least three individual magnets). All magnets have positive and negative poles (magnetic charge orientation, sometimes referred to as south and north poles, respectively). In the devices of this invention, array 15 is such that each one of magnets 17 is oriented and spaced in the array to be located at a different circumferential location 19 around conduit 13 with a common pole 21 of each (either the positive or negative pole, preferably usually the negative) contacting the conduit at its the different circumferential location 19, thus providing a monopole device array.

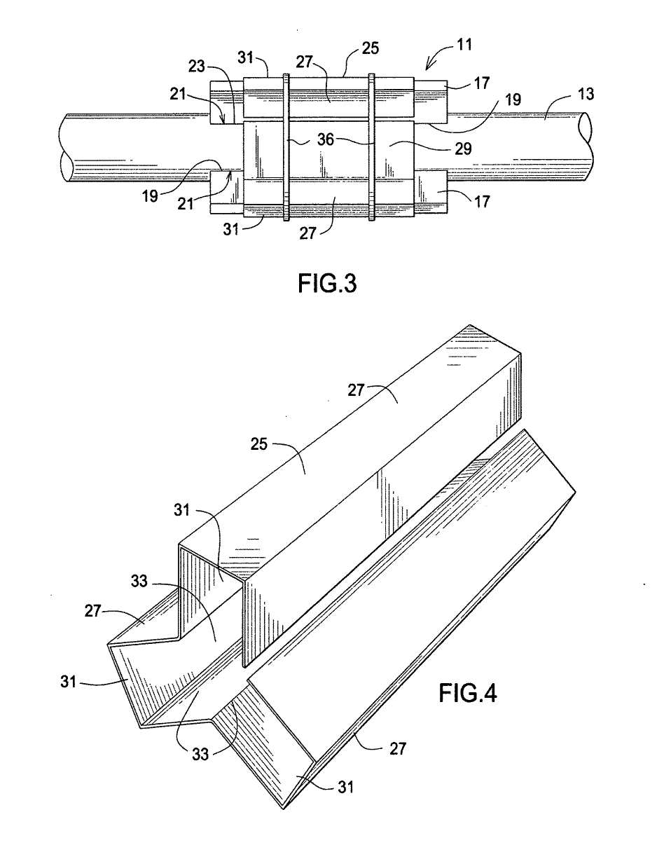

Magnets 17 each have an elongated contact face 23 at common pole 21. Contact faces 23 are each preferably at least about 10 cm in length, the contact faces oriented so that the lengths are positionable along the length of conduit 13 (see FIG. 3). Magnets 17 are preferably at least about a 4,100 gauss heat tolerant permanent magnets or electromagnets made of any suitable material.

As shown in FIG. 1, magnets 17 are arrayed radially at conduit 19 thereby defining polar axes through about the center of conduit 19 and through the poles of each of magnets 17 (one axis only indicated, by arrow A, it being understood that such axes are similarly defined for each of the magnets). Each one of magnets 17 is located off polar axis of any other one of magnets 17 in array 15.

Orienting mount 25 (as best illustrated for this embodiment in FIGS. 2, 4 and 5) is configured to maintain orientation and spacing of magnets 17 in array 15 and enable easy securement of the array on conduit 13. Mount 25 is preferably a one piece construction having insert formations 27 equal in number to the number of magnets 17 in array 15. Each formation 27 is spaced a selected distance 29 from the next formation or from material end 30, dimensionality being selected to obtain magnet location at the selected different circumferential locations 19 given a particular conduit 13 size (see FIGS. 2 and 5). When the fuel delivery conduit is quite small or the number of magnets is relatively large, no distance 29 between elements may be required or achievable achievable (see FIG. 4).

Each of formations 27 is sized to receive and hold at least a middle part of one of magnets 17 therein with the poles of each of the magnets facing the same directions in mount 25. Mount 25 is formed of flexible material, preferably non-ferrous metallic sheet material (for example, aluminum) suitable to disperse heat and configured to secure the magnets against damaging vibrations. Non-metallic materials suitable to the task at hand could also be utilized. Where magnets 17 are bar magnets, formations 27 are preferably an array of substantially parallel u-channels having channel bottoms 31. In such case, the common poles 21 of magnets 17 (preferably most often the negative poles) are positioned at the open ends 33 of the u-channels while the opposite poles 35 (preferably most often the positive poles) face their respective channel bottoms 31 when mounted therein.

Device 11 may employ any suitable means for securing mount 25 and magnets 17 around fuel delivery conduit 13 with magnets 19 contacting the fuel delivery conduit as illustrated. Depending on the installation objectives, known securement devices could be utilized such as plastic ties 36 (where there is adequate ventilation such that excessive heat will present little problem) or metal straps (see FIG. 3).

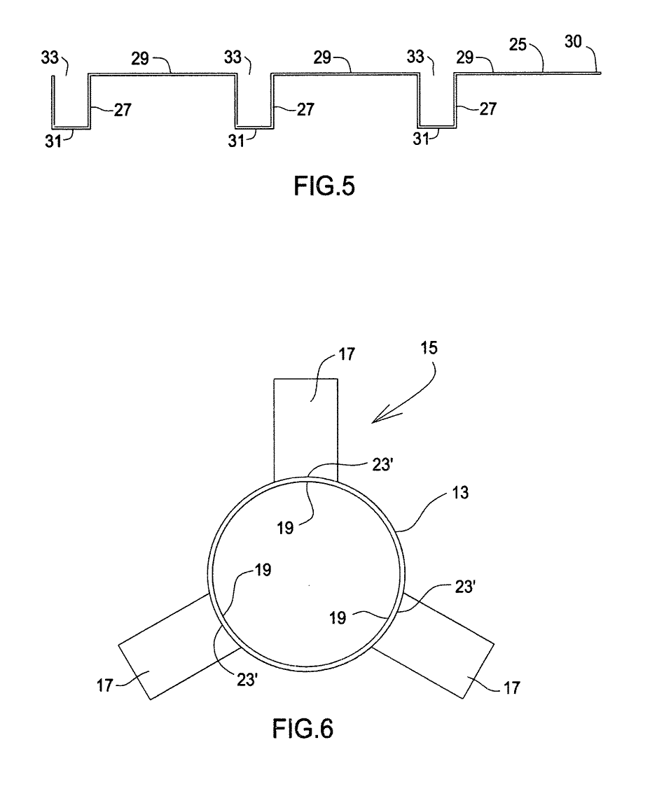

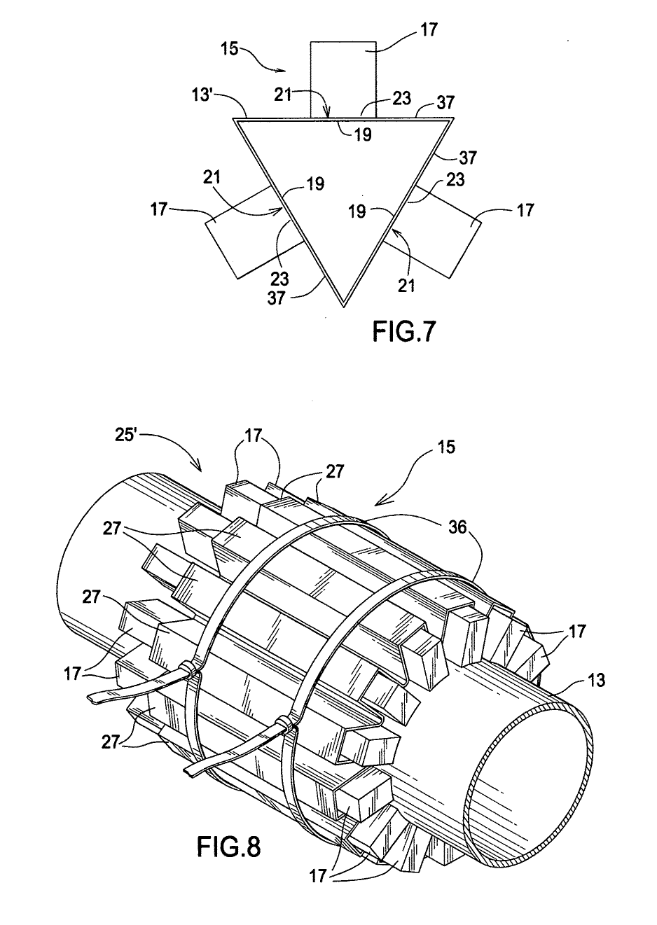

Turning to FIG. 6, when conduit 13 is tubular, contact faces 23′ are preferable appropriately conformed arcuately along the lengths of magnets 17 to closely fit the tubular conduit along substantially the entire surfaces of faces 23′ to provide close contact of faces 23′ along their lengths with the tubular conduit 13. On the other hand, making reference to FIG. 7, specially configured conduit 13′ can be provided for use with this invention wherein the conduit a different geometric construction (other than tubular) or wherein external planar facets 37 equal in number and size to contact faces 23 of magnets 17 are established along conduit 13.

FIG. 8 shows another embodiment of orienting mount 25′ wherein a larger number of insert formations 27 is provided for orienting and securing a greater number of magnets 17 on conduit 13. It is preferred that, in any case, an odd number of insert formations/magnets be utilized with the devices of this invention (for example where multiple devices 11 are interlaced together and attached to a fuel conduit).

Thus in use, a plurality of magnets 17 are oriented with a common pole 21 of each facing the same direction and secured to a fuel delivery conduit 13 adjacent to an area of fuel combustion. The common pole of each of the magnets thereby achieves contact with the conduit. The opposite pole 35 of each magnet 17 is spaced from and faces away from conduit 13 to thereby define a monopole magnet array around the conduit. Device 11 should be secured to the main fuel conduit 13 as close as possible to the injector pump, carburetor, or combustion chamber. A device 11 is preferably mounted on each injector conduit.

As any fluid fuel passes through the monopole magnetic field, the fuel becomes similarly charged thus spreading the fuel more evenly throughout the air that the fuel is dispensed, injected or sprayed into. This results in a greater portion of each fuel molecule being burned providing a more efficient combustion which results in less unburned fuel and other general pollutants of combustion.

Orienting mount 25 may be formed using rotary die. It is then preferably anodized or provided with some other heat resistant coating to prevent the aluminum material from corroding or degrading. The magnet material is preferably Y9 to Y33 steel, preferably about a Y12 to Y14, which is strong, stable and highly resistant to vibration. The magnets can be made out of any material, for example neodymium, alnico, ceramic, ferrite, injection-molded composite of various types of resin and magnetic powders, flexible magnets composed of a high-coercivity ferromagnetic compound (usually ferric oxide) mixed with a plastic binder, rare-earth or rare-earth-free, lanthanoid, samarium-cobalt, neodymium-iron-boron (NIB), and all other types of permanent magnets, or any type of coil or non coil electromagnet where an available charge source can be tapped.

Alternative configurations of the devices of this invention include specially constructed conduits segments wherein magnets 17 are incorporated into the or inside conduit material or wherein magnets 17 are mounted inside the tubing. Other alternatives would see the magnets mounted inside the burner or injector or built into the burner, injector, pump, nozzle, dispenser, or the like.

What is claimed is:

1. A fuel charging device mountable at a length of non-ferrous fuel delivery conduit, said device comprising:
an array of magnets including at least three individual magnets having positive and negative poles, each one of said magnets oriented and spaced in the array to be located at a different circumferential location around the conduit with a common pole of each contacting the conduit at its said different circumferential location, said magnets arrayed radially to define polar axes through about the center of the conduit and through said poles of each one of said magnets, each one said magnets located off polar axis of any other one of said magnets in said array.

2. The device of claim 1 wherein said common pole of said each of said magnets is said negative pole.

3. The device of claim 1 further comprising an orienting mount for maintaining orientation and spacing of said magnets in said array and for enabling securement of said array on the conduit.

4. The device of claim 1 wherein each of said magnets has a contact face at said common pole with at least about a 10 cm length, said contact faces oriented so that said lengths are positionable along the length of the conduit.

5. Claim 4 wherein the conduit is a tubular conduit, wherein said device faces are selectively arcuately formed along said lengths to provide close contact of said faces along said lengths with said tubular conduit.

6. The device of claim 4 wherein said conduit is provided with external planar facets equal in number and size to said faces of said magnets.

7. The device of claim 1 wherein each of said magnets is at least about a 4,100 gauss heat tolerant magnet, each of said magnets being either a permanent magnet or an electromagnet.

8. A monopole fuel molecule charging device for mounting on a fuel delivery conduit comprising:
at least three individual magnets having positive and negative poles;
a one piece orienting mount having insert formations equal in number to the number of said individual magnets and located adjacent to each other, each of said insert formations sized to receive and hold at least a part of one of said magnets therein; and
each one of said magnets oriented in a different one of said insert formations of said mount with said poles of each of said magnets facing the same directions in said mount.

9. The device of claim 8 wherein said mount is formed of flexible non-ferrous material.

10. The device of claim 8 wherein said insert formations of said mount are u-channels each having a channel bottom, wherein said magnets are bar magnets, and wherein said positive poles of said magnets face their respective said channel bottom when mounted.

11. The device of claim 10 wherein said u-channels are arrayed substantially parallel to one another with a selected distance defined between each.

12. The device of claim 8 further comprising securement means for securing said mount having said magnets installed therein around the fuel delivery conduit with said magnets contacting the fuel delivery conduit.

13. The device of claim 12 wherein said magnets are arrayed in said mount to define polar axes through about the center of the pipe and through said poles of each one of said magnets once said mount is secured, with each one of said magnets located off polar axis of any other one of said magnets.

14. A fuel molecule charging method comprising the steps of:
orienting a plurality of magnets having positive and negative poles with a common pole of each facing the same direction; and
securing the magnets to a fuel delivery conduit adjacent to an area of fuel combustion so that the common pole of each of the magnets contacts the conduit and an opposite pole of each is spaced from and faces away from the conduit to thereby define a monopole magnet array around the conduit.

15. The method of claim 14 further comprising the step of locating the magnets at different circumferential locations around the conduit with the common pole of each contacting the conduit at its the different circumferential location.

16. The method of claim 14 further comprising the step of arranging and locating the magnets radially to define polar axes through about the center of the pipe and through the poles of each one of the magnets with each one the magnets located off polar axis of any other one of the magnets.

17. The method of claim 14 wherein each one of the magnets has an elongated face with a length at the common pole, and wherein the step of securing the magnets includes contacting the faces of the magnets so the lengths thereof are oriented along conduit length.

18. The method of claim 14 wherein the step of orienting a plurality of magnets includes orienting the magnets in a mount configured for maintaining orientation and spacing of the magnets, and wherein the step of securing the magnets includes securing the mount on the conduit.

19. The method of claim 17 wherein the conduit is tubular and wherein each one of the magnets has an elongated face with a length at the common pole, the method further comprising conforming the faces of the magnets to closely fit the tubular conduit along substantially the entire surfaces of the faces.
